(19) United States
(12) Patent Application Publication
(10) Pub. No.: US 2006/0209091 A1
(43) Pub. Date: Sep. 21, 2006

(54) Methods, systems, and software for facilitating the framing of artwork

(76) Inventor: Kenneth S. Post, Newport Coast, CA (US)

Correspondence Address: STETINA BRUNDA GARRED & BRUCKER, 75 ENTERPRISE, SUITE 250, ALISO VIEJO, CA, 92656, US

(21) Appl. No.: 11/037,697

(22) Filed: Jan. 18, 2005

(51) Int. Cl. G09G 5/00

(52) U.S. Cl. 345/635

(57) ABSTRACT

Digital images comprising artwork, matting samples, and molding samples can be received and accessed by a system. Various points selected on the digital image can be received by the system. Using the selected points, the system can render images illustrating the artwork surrounded by a full matting and molding of the types set forth in the samples of the original digital images. The system can also display a user-selected wall color behind and/or in proximity to the rendered images. By viewing the rendered images and/or selected wall colors, a user of the system can visualize how the artwork will likely appear when finally framed and positioned near a wall, even if only matting and molding samples are available at the time the images are created.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Field of the Invention

The present invention is directed to technology for facilitating the framing of artwork.

2. Description of the Related Art

The appearance of artwork can be influenced by many factors. For example, the selection of a particular matting or molding can often add or detract from the overall aesthetic appearance of framed artwork. Similarly, when artwork is placed in proximity to a wall, the color of the wall may complement or clash with various aspects of the artwork. Consequently, each of these design elements must be carefully selected in order to provide an appropriate complementary visual impact to the artwork.

When selecting the matting and molding to be used for framing artwork, a person will typically position small sections of various moldings and mattings next to the artwork. Nevertheless, it can be difficult to visualize how the complete molding and matting will appear in conjunction with the artwork after it is framed, especially when only small samples of moldings and mattings are available for comparison. This is especially the case for ordinary consumers or persons with minimal framing experience who may be forced to rely on the judgment of more experienced professionals when making these selections.

Accordingly, it can be extremely difficult to evaluate the combined impact of matting and molding selections until after the framing has been completed. Unfortunately, even if the finished framed artwork does not meet the imagined expectations of a consumer, this realization may not occur until after significant amounts of time and money have been expended to frame the artwork. Moreover, even if the finished artwork appears acceptable to the consumer at a given location, it still may not be possible to appreciate the overall impact of the artwork in conjunction with wall colors until after the artwork is finally installed.

### BRIEF SUMMARY OF THE INVENTION

The present invention, roughly described, provides improved methods, systems, and software for facilitating the framing of artwork. In one embodiment, a machine-implemented method is provided for facilitating visualization of artwork. A digital image comprising the artwork, a matting sample, and a molding sample can be accessed. Various user-selected points can be received, including: a first point defining an outside corner of the molding sample, a second point defining an inside corner of the molding sample where the matting sample meets the molding sample, a third point defining a molding repeat point, a fourth point defining a matting corner where the matting sample meets a first corner of the artwork, and a fifth point defining a second corner of the artwork. An image can be rendered in response to the points and displayed to the user. In various embodiments, the rendered image can include: at least a portion of the artwork, a continuous matting surrounding the at least a portion of the artwork, and a continuous molding surrounding the continuous matting and the at least a portion of the artwork.

In another embodiment, a method for facilitating visualization of artwork can be provided by software operable to perform the method when run by a computer, the software being embodied in a computer readable medium. These as well as other embodiments contemplated by the present invention will be more fully set forth in the detailed description below and the figures submitted herewith.

### BRIEF DESCRIPTION OF THE DRAWINGS

FIG. 1 illustrates a block diagram of a system and work surface for facilitating the visualization of artwork in accordance with an embodiment of the present invention.

FIGS. 2A-2C illustrate a process for visualizing artwork in accordance with an embodiment of the present invention.

FIGS. 3A-3C illustrate a user interface provided by software to facilitate a process for visualizing artwork in accordance with an embodiment of the present invention.

### DETAILED DESCRIPTION OF THE INVENTION

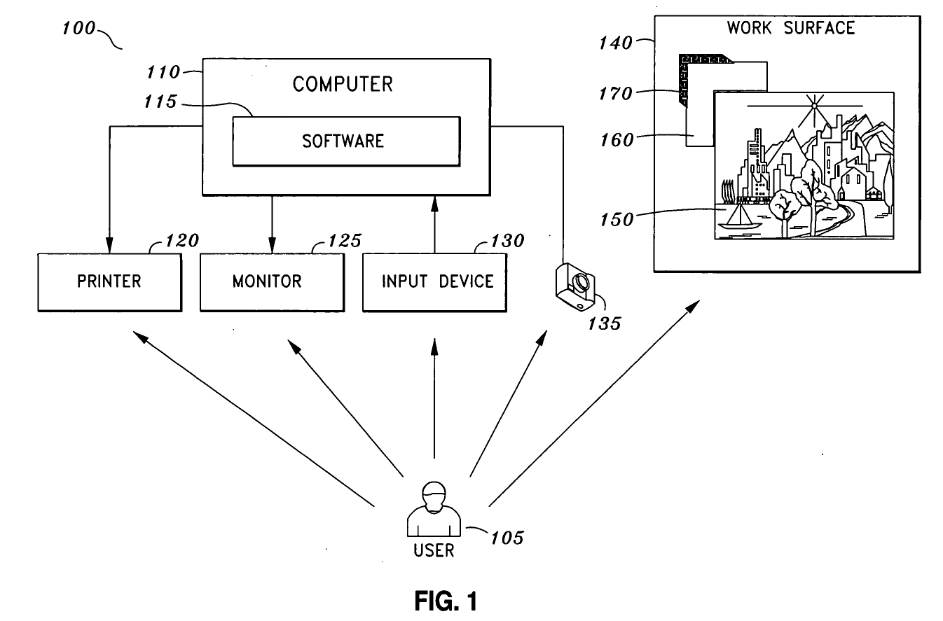

FIG. 1 illustrates a block diagram of a system 100 and work surface 140 for facilitating the visualization of artwork in accordance with an embodiment of the present invention. Through the operation of system 100 in conjunction with work surface 140, a user 105 can create and view rendered images to aid the user 105 in determining appropriate combinations of moldings, mattings, wall colors, and/or artwork.

Digital images of artwork, matting samples, and molding samples can be provided to the system 100. Upon receiving input by the user 105, the system 100 can render images that illustrate the artwork surrounded by a full matting and molding of the types set forth in the samples of the original digital images. The system 100 can also display a user-selected wall color behind and/or in proximity to the rendered images. Thus, by viewing the rendered images and/or selected wall colors, the user 105 can understand how the artwork will likely appear when finally framed and positioned near a wall, even if only matting and molding samples are available at the time the images are created.

In various embodiments, the user 105 can be a framer, craftsperson, customer, consumer, or any other person who may desire to use the system 100 or work surface 140, or view images rendered by the system 100. It is contemplated that the system 100 and work surface 140 can be preferably situated in the workplace of a craftsperson such as a professional framer to aid the craftsperson in preparing rendered images for viewing by the craftsperson and/or customers. However, it is further contemplated that the system 100 and work surface 140 need not be limited to such locales or applications. As such, the system 100 and/or work surface 140 can be situated in any location where a user 105 may desire to utilize the various components of the system 100 and/or work surface 140.

As illustrated, the system 100 can include a computer 110 with software 115 running on the computer, allowing the computer to perform various steps as further set forth herein. Computer 110 can be implemented as any appropriate general purpose or specialized computer(s) known in the art. Software 115 can be implemented as any appropriate software program(s), application(s), or component(s) running on one or more computers. In one embodiment, computer 110 is a computer running a Windows™ XP operating system with Microsoft .NET 1.1 functionality.

An input device 130 in communication with computer 110 can receive data input by the user 105 for operating the system 100. It will be appreciated that the input device 130 can be any appropriate type of input device known in the art, including but not limited to a keyboard, mouse, touchpad, trackball, and/or other appropriate input devices.

System 100 can also provide a monitor/display 125 in communication with computer 110 for displaying output of the system 100, such as images accessed and/or rendered by the system 100 as further described herein. Such output can also be provided to printer 120 in communication with computer 110.

System 100 can further include a camera 135 for capturing digital images. The digital images can be acquired by the computer 110 for further processing by the system 100 as further described herein. It will be appreciated that camera 135 can be a digital camera or any other suitable device for capturing digital images and providing such images to computer 110 through an appropriate interface known in the art. As such, it will be appreciated that the work surface 140 need not be in proximity to the system 100.

As illustrated, various items can be positioned on work surface 140, including artwork 150, a matting sample 160, and a molding sample 170. Typically, matting sample 160 and molding sample 170 will be placed in proximity to a corner of the artwork 150 as set forth in FIG. 1. Although such items have been illustrated in relation to the upper left corner of the artwork 150, any corner may be utilized. Digital images of the work surface 140 and the various items thereon can be captured by camera 135. Although it is preferred that camera 135 be positioned vertically above the work surface 140, it will be appreciated that camera 135 can be oriented in any manner to capture digital images of the work surface for use by system 100.

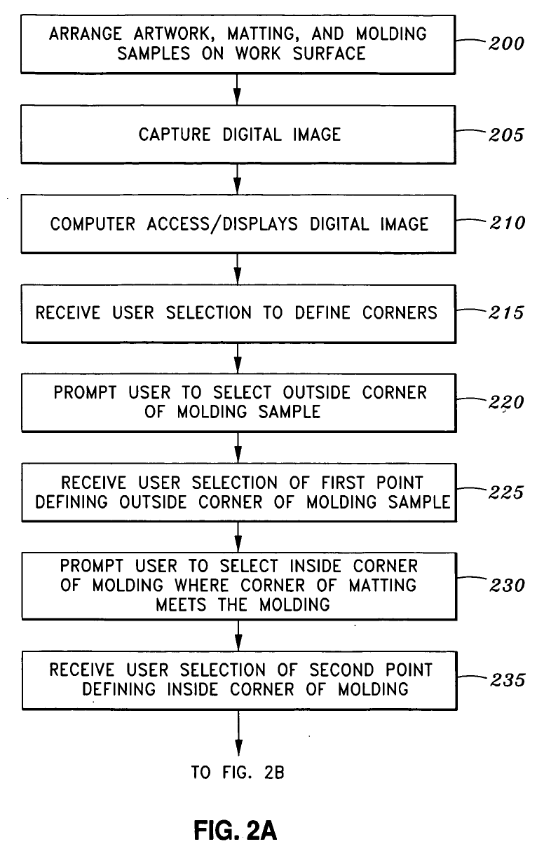

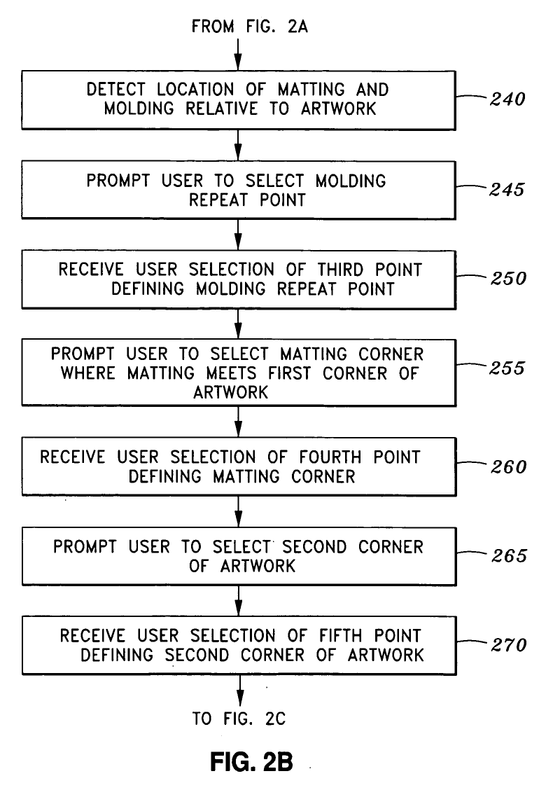

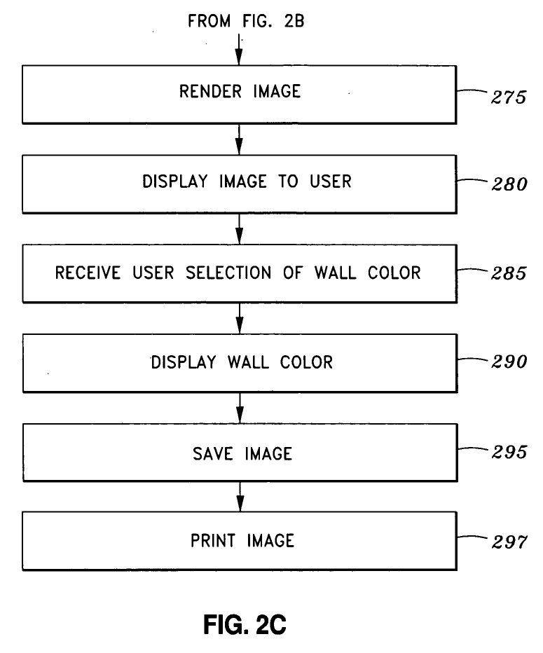

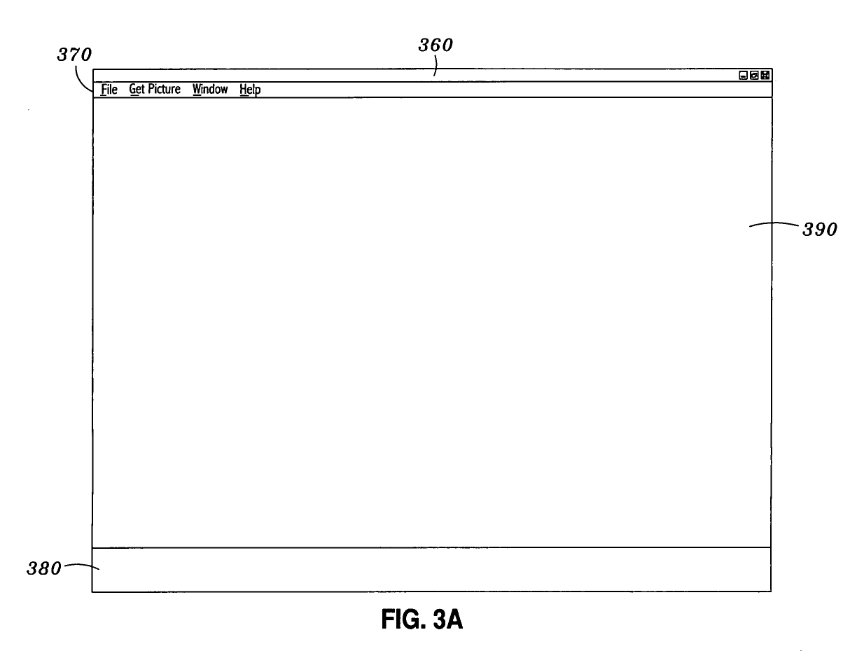

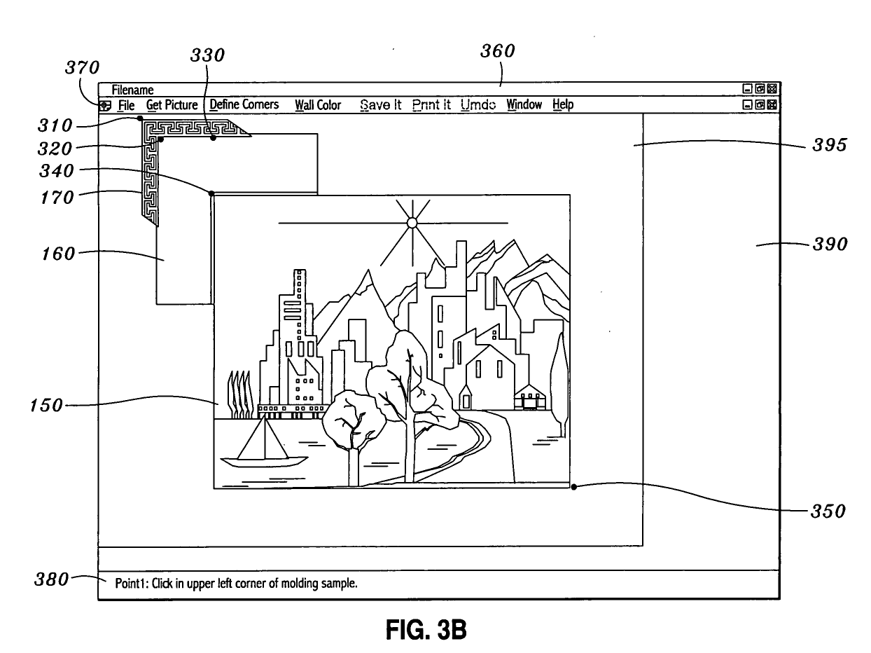

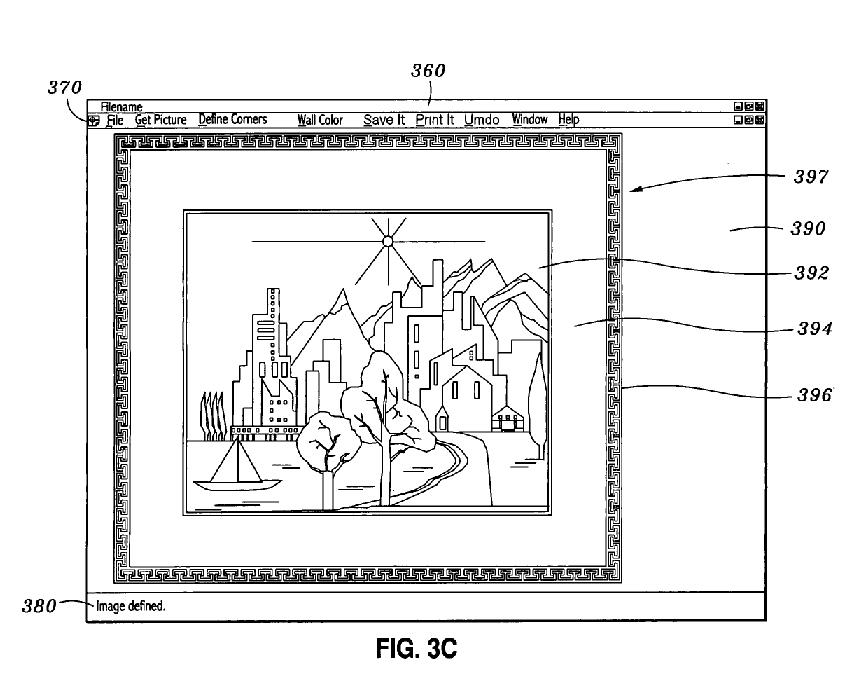

FIGS. 2A-2C illustrate a process for visualizing artwork in accordance with an embodiment of the present invention. The user's interaction with system 100 during the process of FIGS. 2A-2C can be facilitated through the use of a graphical user interface displayed on monitor 125. FIGS. 3A-3C illustrate an embodiment of one such user interface. As set forth in FIGS. 3A-3C, the user interface can comprise various windows and bars in a convenient graphical user interface format.

A menu bar 370 provides various menus and buttons that can be accessed by the user 105. For example, a “File” menu can be provided for opening, saving, and printing images, as well as for exiting the software 115. A “Get Picture” button, “Define Corners” button, “Wall Color” button, “Save It” button, and “Print It” button can be provided for allowing the user 105 to initiate various functionality as further described herein. An “Undo” button can also be provided for removing the effect of a previous action taken by the user 105 in relation to the software 115. As illustrated, the menu bar 370 also includes “Window” and “Help” menus that are familiar to modern computer users. As will be appreciated from FIGS. 3A-3C, the availability of the various buttons/menus of the menu bar 370 depends on the current state of the visualization process. Accordingly, various buttons/menus that are not currently available for interaction by the user 105 can be displayed in a less significant (i.e. grayed out) format or not displayed in the user interface.

A main display window 390 allows the user 105 to view various images and wall colors, and also select various points/corners as further described herein. A title bar 360 can be provided for displaying the filename associated with an image currently accessed by the software 115. In addition, a prompt window 380 can be provided for displaying prompts to the user 105 for identifying the next action the user 105 should take. Alternatively and/or in addition to prompt window 380, prompts can be provided in the form of bubble help displayed in an upper left portion of window 390.

Referring again to the process of FIGS. 2A-2C, the user 105 can initially arrange artwork 150, a matting sample 160, and a molding sample 170 on the work surface 140 (step 200). The user 105 then employs camera 135 or another suitable device to capture a digital image that comprises the elements on the work surface 140 (step 205). The digital image can then be provided to the computer 110. Upon receiving the image, the computer 110 can store the image as a file maintained in memory, hard disk, and/or any appropriate volatile or non-volatile storage medium known in the art. The image can be formatted in any appropriate graphical file format, such as a bitmap file, JPEG file, and/or other file formats known in the art.

At step 210, the computer 110 accesses and displays the digital image using software 115. For example, the accessing step 210 can be performed by the software 115 in response to the user's selection of a “Get Picture” button displayed in the menu bar 370 of the user interface. As illustrated in FIG. 3B, the software 115 can display the image 395 in display window 390.

At step 215, the software 115 receives the user's selection to begin defining various points to be used by the software 115 for rendering an image, as further described herein. In one embodiment, the user 105 can initiate these steps by selecting the “Define Corners” button displayed in the menu bar 370 of FIG. 3B.

Upon receiving the user's selection to define corners, the software 115 proceeds to prompt the user 105 to select a series of points that will be used by the software 115 to render an image showing a representation of the artwork 150 with a matting and molding surrounding the artwork 150, based on the sample matting and molding 160 and 170 set forth in the digital image 395.

At step 220, the software 115 prompts the user 105 to select an outside corner of the molding sample 170 of digital image 395. The prompt of step 220 as well as other prompts called for in the process of FIGS. 2A-2C can be displayed in prompt window 380. In response, the user 105 can select a first point, such as point 310 of FIG. 3B, which is received by the software 115 (step 225).

At step 230, the software 115 prompts the user 105 to select an inside corner of the molding sample 170 where a corner of the matting sample 160 meets the molding sample 170. In response, the user can select a second point, such as point 320 of FIG. 3B, which is received by the software 115 (step 235).

At step 240, the software 115 detects the location of the matting sample 160 and the molding sample 170 relative to the artwork 150. In this regard, it will be appreciated that although the matting sample 160 and molding sample 170 of the digital image 395 have been illustrated as being positioned near the upper left corner of the artwork 150, such elements can alternatively be positioned near any of the corners of the artwork 150. By comparing the locations of the first and second points (i.e. corner selections) received in steps 225 and 235, the software 115 can determine which corner of the artwork 150 is positioned next to the molding sample 170 and matting sample 160.

For example, if the first point received in step 225 is located above the second point received in step 235, then the software 115 can determine that the molding and matting samples 170 and 160 are positioned next to one of the upper two corners of the artwork 170. In addition, if the first point received in step 225 is located to the left of the second point received in step 235, then the software 115 can determine that the molding and matting samples 170 and 160 are positioned next to one of the left two corners of the artwork 170. Thus, by comparing the relative positions of the first and second points, the software 115 can readily detect which corner of the artwork 150 is positioned next to the molding and matting samples 170 and 160.

At step 245, the software 115 prompts the user 105 to select a molding repeat point. Moldings often contain ornamental patterns that are periodically repeated throughout the molding. By selecting a molding repeat point, the user 105 can identify a portion of the molding that comprises a pattern to be repeated in the continuous molding to be included in the image rendered by the software 115. It will be appreciated that by repeating this pattern, the system 100 can allow the user 105 to view an accurate rendition of a full molding having the repeating ornamental pattern of the molding sample 170. In response to the prompt of step 245, the user can select a third point defining a molding repeat point, such as point 330 of FIG. 3B, which is received by the software 115 (step 250). If the molding sample 170 does not include a pattern to be repeated, the molding repeat point can be selected at any appropriate location to identify the portion of the molding sample 170 to be used when rendering the image. For example, the molding repeat point could be selected to correspond to a location approximately ⅛″ away from the inside corner of the molding sample selected in step 235.

At step 255, the software 115 prompts the user 105 to select a matting corner where the matting sample 160 meets a first corner of the artwork 150. In response, the user can select a fourth point, such as point 340 of FIG. 3B, which is received by the software 115 (step 260).

At step 265, the software 115 prompts the user 105 to select a second corner of the artwork 150. Typically, the second corner will be a corner of the artwork 170 that is diagonally across from the first corner of the artwork described above in relation to steps 255 and 260. In response to the prompt of step 265, the user can select a fifth point, such as point 350 of FIG. 3B, which is received by the software 115 (step 270).

After receiving the user's selection of the various points identified above, the software 115 renders and displays an image that includes the artwork 170, a continuous matting surrounding the artwork 170, and a continuous molding surrounding the continuous matting and the artwork 170 (steps 275 and 280).

FIG. 3C illustrates a sample image 397 rendered in accordance with step 275 and displayed in accordance with step 280. As illustrated, the rendered image 397 can include a rectangular portion 392 of the artwork 150 having opposite corners defined by the fourth and fifth points (340 and 350, respectively) selected by the user 105. The rendered image 397 can also include a continuous matting 394 surrounding the portion 392 of the artwork 150. It will be appreciated that the continuous matting 394 is a graphical representation of how the artwork 150 would appear when surrounded by a matting of the type represented in the matting sample 160.

The continuous matting 394 of rendered image 397 can be created as follows. A rectangular portion of the matting sample 160 having opposite corners defined by the second and fourth points (320 and 340, respectively) can be placed at each of the corners of the artwork 150 displayed in image 397. The top and bottom portions of the continuous matting 394 can be created by repeating a rectangular portion of the matting sample 160 having a lower left corner defined by the fourth point 340, an upper left corner defined by a point having an x-coordinate equal to that of the fourth point 340 and a y-coordinate equal to that of the second point 320, and a horizontal dimension defined by a fixed distance (typically several pixels) to the right of the fourth point 340. The left and right portions of the continuous matting 394 can be created by repeating a rectangular portion of the matting sample 160 having an upper right corner defined by the fourth point 340, an upper left corner defined by a point having an x-coordinate equal to that of the second point 320 and a y-coordinate equal to that of the fourth point 340, a bottom right corner vertically disposed below the fourth point 340 by a fixed distance (typically several pixels) below the fourth point 340, and a bottom left corner defined by a point having an x-coordinate equal to that of the second point 320 and a y-coordinate equal to that of the bottom right corner of the rectangle.

The rendered image 397 can also include a continuous molding 396 surrounding the continuous matting 394 and the portion 392 of the artwork 150. It will be appreciated that the continuous molding 396 is a graphical representation of how the artwork 150 would appear when surrounded by a molding of the type represented in the molding sample 170.

The continuous molding 396 of rendered image 397 can be created as follows. A rectangular portion of the molding sample 170 having opposite corners defined by the first and second points (310 and 320, respectively) can be placed at each of the corners of the image 397. It will be appreciated that the portion of the molding sample 170 used for each corner can be reversed vertically and or horizontally in order to preserve any pattern incident to the molding sample 170. The top and bottom portions of the continuous molding 396 can be created by repeating a rectangular portion of the molding sample 170 having lower corners defined by the second and third points (320 and 330, respectively), and a vertical dimension defined by the vertical distance between the first and second points (310 and 320, respectively). The left and right portions of the continuous molding 396 can be created by repeating a rectangular portion of the molding sample 170 having an upper right corner defined by the second point 320, an upper left corner defined by a point having an x-coordinate equal to that of the first point 310 and a y-coordinate equal to that of the second point 320, a bottom right corner vertically disposed below the second point 320 by a distance equal to the horizontal distance between the second and third points (320 and 330, respectively), and a bottom left corner defined by a point having an x-coordinate equal to that of the first point 310 and a y-coordinate equal to that of the bottom right corner of the rectangle.

Referring again to FIGS. 2A-2C, after the rendered image 397 is displayed in step 280, a user 105 may select a particular wall color to be displayed behind and/or in proximity to the rendered image 397 in display window 390. In one embodiment, the user 105 can select the wall color by selecting the “Wall Color” button in menu bar 370 of FIG. 3C and choosing a wall color from various choices displayed to the user 105. Upon receiving the user's selection of a wall color (step 285), the software 115 displays the selected wall color behind the rendered image 397 (step 290).

The user 105 may also choose to save (step 295) and/or print (step 297) the rendered image 397 by selecting the “Save It” or “Print It” buttons in menu bar 370, respectively.

It is contemplated that there may be instances where the user 105 may wish to frame artwork 150 without a matting. In such circumstances, the matting sample 160 need not be utilized. Instead, the molding sample 170 can be placed directly adjacent to the artwork 150 on work surface 140 without any intermediate matting sample 160, and the selection of points in the process of FIGS. 2A-2C can be modified. Specifically, steps 230 and 235 can be modified such that the second point corresponds to an inside corner of the molding sample 170 where a corner of the artwork 150 meets the molding sample 170. In addition, steps 255 and 260 can be modified such that the fourth point approximately (i.e. within several pixels) corresponds/coincides with the second point.

Where applicable, the present invention can be implemented using hardware, software, or combinations of hardware and software. Also where applicable, the various hardware components and/or software components set forth herein can be combined into composite components comprising software, hardware, and/or both without departing from the spirit of the present invention. Where applicable, the various hardware components and/or software components set forth herein can be dissected into sub-components comprising software, hardware, or both without departing from the spirit of the present invention. In addition, where applicable, it is contemplated that software components can be implemented as hardware components, and vice-versa.

Software in accordance with the present invention, such as program code and/or data, can stored on one or more computer readable mediums. It is also contemplated that software identified herein can be implemented using one or more general purpose or specific purpose computers and/or computer systems, networked and/or otherwise.

Where applicable, the ordering of various steps described herein can be changed, combined into composite steps, and/or dissected into sub-steps to provide the functionality described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure.

For example, it is contemplated that the principles set forth herein can be used to render images for facilitating visualization of artwork, mattings, and/or moldings having shapes other than those explicitly described herein (for example, oval and round shapes). As another example, it is contemplated that rendered images can be displayed in window 390 as being superimposed over an imported picture of a room, thereby permitting the user 105 to further visualize the finished framed artwork as it may appear in the room.

What is claimed is:

1. A machine-implemented method for facilitating visualization of artwork, the method comprising:
accessing a digital image comprising:
an artwork,
a matting sample, and
a molding sample;
receiving a user selection of a first point defining an outside corner of the molding sample;
receiving a user selection of a second point defining an inside corner of the molding sample where the matting sample meets the molding sample;
receiving a user selection of a third point defining a molding repeat point;
receiving a user selection of a fourth point defining a matting corner where the matting sample meets a first corner of the artwork;
receiving a user selection of a fifth point defining a second corner of the artwork;
rendering an image in response to the receiving steps, the rendered image comprising:
at least a portion of the artwork,
a continuous matting surrounding the at least a portion of the artwork, and
a continuous molding surrounding the continuous matting and the at least a portion of the artwork; and
displaying the rendered image.

2. The method of claim 1 further comprising:
detecting a location of the matting sample and the molding sample relative to the artwork in response to the first and second receiving steps.

3. The method of claim 1 further comprising:
prompting the user prior to each of the receiving steps.

4. The method of claim 1, the digital image is acquired from a digital camera.

5. The method of claim 1, the user selections are performed by the user manipulating a mouse.

6. The method of claim 1, the method is performed by software running on a computer.

7. The method of claim 1 further comprising:
receiving a user selection of a wall color; and
displaying the wall color in proximity with the rendered image.

8. A computer readable medium with application software embodied therein, the software operable to perform a method for facilitating visualization of artwork when run by a computer, the method comprising the steps of:
accessing a digital image comprising:
an artwork,
a matting sample, and
a molding sample;
receiving a user selection of a first point defining an outside corner of the molding sample;
receiving a user selection of a second point defining an inside corner of the molding sample where the matting sample meets the molding sample;
receiving a user selection of a third point defining a molding repeat point;
receiving a user selection of a fourth point defining a matting corner where the matting sample meets a first corner of the artwork;
receiving a user selection of a fifth point defining a second corner of the artwork;
rendering an image in response to the receiving steps, the rendered image comprising:
at least a portion of the artwork,
a continuous matting surrounding the at least a portion of the artwork, and
a continuous molding surrounding the continuous matting and the at least a portion of the artwork; and
displaying the rendered image.

9. The computer readable medium of claim 8 the method further comprising:
detecting a location of the matting sample and the molding sample relative to the artwork in response to the first and second receiving steps.

10. The computer readable medium of claim 8, the method further comprising:
prompting the user prior to each of the receiving steps.

11. The computer readable medium of claim 8, the digital image is acquired from a digital camera.

12. The computer readable medium of claim 8, the user selections are performed by the user manipulating a mouse.

13. The computer readable medium of claim 8, the method further comprising:
receiving a user selection of a wall color; and
displaying the wall color in proximity with the rendered image.

14. A method for visualizing artwork with a computer, the method comprising:
selecting a digital image comprising:
an artwork,
a matting sample, and
a molding sample;
selecting a first point that defines an outside corner of the molding sample;
selecting a second point that defines an inside corner of the molding sample where the matting sample meets the molding sample;
selecting a third point that defines a molding repeat point;
selecting a fourth point that defines a matting corner where the matting sample meets a first corner of the artwork;
selecting a fifth point that defines a second corner of the artwork; and
viewing a rendered image, the rendered image being created by the computer in response to the selecting steps, the rendered image comprising:
at least a portion of the artwork,
a continuous matting surrounding the at least a portion of the artwork, and
a continuous molding surrounding the continuous matting and the at least a portion of the artwork.

15. The method of claim 14 further comprising:
capturing the digital image using a digital camera prior to the first selecting step.

16. The method of claim 14, the selecting steps are performed by a user manipulating a mouse.

17. The method of claim 14 further comprising:
selecting a wall color; and
viewing the wall color in proximity with the rendered image.

18. A machine-implemented method for facilitating visualization of artwork, the method comprising:
accessing a digital image comprising:
an artwork, and
a molding sample;
receiving a user selection of a first point defining an outside corner of the molding sample;
receiving a user selection of a second point defining an inside corner of the molding sample where the artwork meets the molding sample;
receiving a user selection of a third point defining a molding repeat point;
receiving a user selection of a fourth point approximately corresponding to the second point;
receiving a user selection of a fifth point defining a second corner of the artwork;
rendering an image in response to the receiving steps, the rendered image comprising:
at least a portion of the artwork, and
a continuous molding surrounding the at least a portion of the artwork; and
displaying the rendered image.
